(19) United States
(12) Patent Application Publication
(10) Pub. No.: US 2012/0152456 A1
(43) Pub. Date: Jun. 21, 2012

(54) CONNECTING PROFILE, STRUCTURE FIXED TO THE EDGE OF A SURFACE TO BE WET-SEALED, AND METHOD

(76) Inventors: Mika Lokkinen, Porvoo (FI); Juho Lokkinen, Monninkyla (FI)

(21) Appl. No.: 13/326,286

(22) Filed: Dec. 14, 2011

(30) Foreign Application Priority Data
Dec. 15, 2010 (FI) 20106320

(51) Int. Cl. F16L 13/10; B32B 37/12

(52) U.S. Cl. 156/293; 285/285.1

(57) ABSTRACT

A connecting profile for binding water sealing paste to a structure at an edge of a zone to be protected by wet sealing. The connecting profile is adapted to be attached tightly to the structure and that the installed connecting profile comprises or forms together with the structure at least one groove which is adapted to receive water sealing paste applied on the connecting profile. Also provided is the structure, for example a floor drain, that has the connecting profile and a method for attaching water sealing paste on the connecting profile or on the structure.

### PRIOR APPLICATION

This US patent application claims priority from Finnish patent application no. 20106320, filed 15 Dec. 2010.

### FIELD OF THE INVENTION

The invention relates to a connecting profile element used for wet sealing of wet rooms, for example bathrooms, and a wet sealing method.

### BACKGROUND AND SUMMARY OF THE INVENTION

Wet sealing of floor drain according to prior art requires a plurality of working steps, and in many of these steps great care must be taken in order to make the wet sealing reliably waterproof. In a typical method, a porous reinforcing fabric impregnated with water sealing paste is fixed around the mouth opening of the floor drain by means of a clamp ring and a gasket. Any minor errors in any of the working steps, for example in impregnating the reinforcing fabric with water sealing paste or in fixing the clamp ring, may leave an opening in the sealing through which moisture may enter for example in the floor casting, The gasket of the clamp ring may also become bristle in the long-term, may loose its sealing capacity and therefore let moisture inside the structures of the building.

The object of this invention is to provide a method and means for connecting a structure, for example a floor drain, to be mounted to the edge of a surface to be wet-sealed to a wet sealing in tight and simple manner.

An aspect of the invention is a connecting profile for binding water sealing paste to a structure at the edge of a zone to be protected by wet sealing. The connecting profile is characterized in that it is adapted to be attached tightly to the structure and that the installed connecting profile comprises or forms together with the structure at least one groove which is adapted to receive water sealing paste applied on the connecting profile.

In an embodiment of the invention the groove of the connecting profile is openable/extendable towards the inside, i.e. it for example comprises a broader and a narrower point, the narrower point being situated closer to the upper surface of the installed connecting profile than the broader point. At least one opening may be arranged on the broader point of the groove for leading gas out of the groove during application of water sealing paste.

The structure may be for example a floor drain element or part of it. The connecting profile may be adapted to be attached fixedly and/or tightly to a floor drain element or part of it.

The material of the connecting profile may advantageously be a material impermeable to water sealing paste.

Another aspect of the invention is a structure, for example a floor drain element or part of it, which may be fixed to the edge of a surface to be sealed by water sealing paste. The structure may be characterized in that it comprises a connecting profile which comprises at least one groove, which is adapted to receive water sealing paste applied on the connecting profile.

The connecting profile may be adapted to be mounted substantially on the level of the surface to be wet-sealed.

A third embodiment of the invention is a method for attaching water sealing paste to the edge of a zone to be protected by wet sealing using the above-mentioned connecting profile or element.

### BRIEF DESCRIPTION OF THE DRAWINGS

In the following the invention will be explained in further detail with reference to preferred exemplary embodiments and annexed Drawings, in which:

FIG. 1 shows a connecting profile according to an embodiment of the invention; and

FIGS. 2a and 2b show the use of a connecting profile according to another embodiment of the invention as part of a floor drain arrangement.

### DETAILED DESCRIPTION

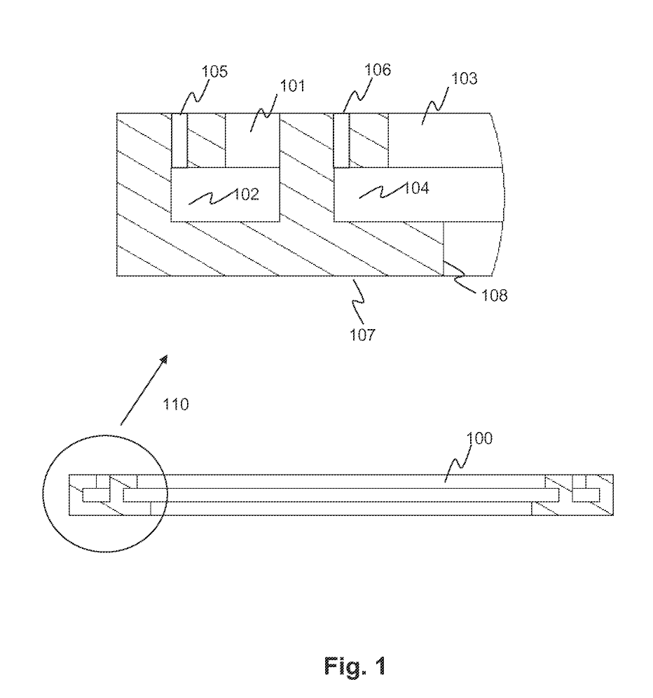

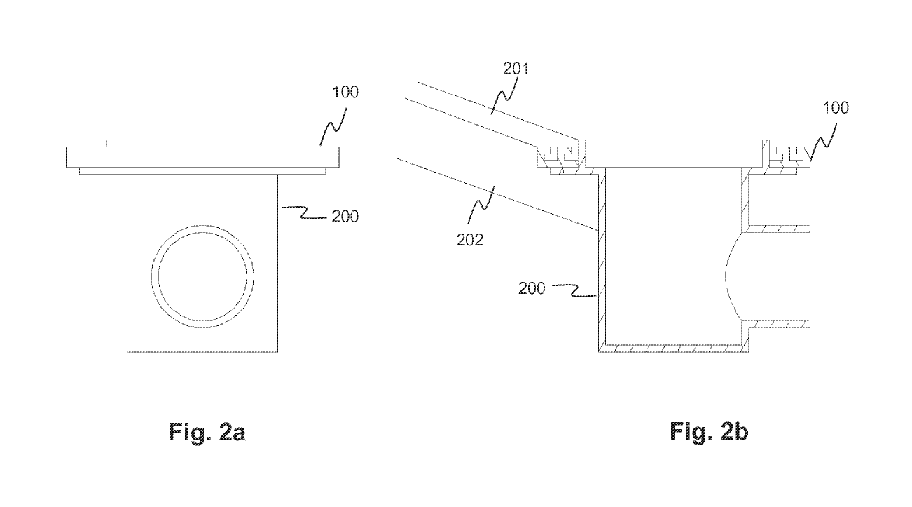

FIG. 1 shows a cross-section and a partial enlargement 110 of a connecting profile 100 for attaching water sealing paste to a structure situated at the edge of a zone to be wet-sealed, such as a floor drain. The connecting profile 100 comprises a first groove 101, which broadens towards the inside of the connecting profile 100 forming a broader point 102 inside the first groove 101. The form of the connecting profile 100 is such that it may be mounted fixedly and tightly to a structure, for example a cylindrical or rectangular floor drain element. In the example of the Figure the zones 103 and 104 of the connecting profile 100 form a second groove 103, in which a point 104 of the connecting profile 100 is broadening towards the inside, when the connecting profile 100 is fixed to the structure. During application of water sealing paste on the connecting profile 100, the paste penetrates the grooves 101, 103 of the connecting profile and in particular the broader points 102, 104 of the grooves. Air trapped in the grooves exits via openings 105, 106 of the connecting profile. After drying the water sealing paste is adhered tightly on the walls of the grooves forming a sealing profile thickening towards the inside. Thanks to the paste engaged to the surface of the connecting profile 100 and in particular the grooves 101, 103 thereof, the edge of the wet sealing is made water tight and reliably positioned. The connecting profile 100 is adapted to be attached tightly to a structure, such as a floor drain element (200 in FIGS. 2a and 2b), for example by welding or gluing the surface 107 and/or surface 108 to the structure.

Water sealing paste may be any paste well known to the person skilled in the art, which is mounted by applying and used for wet sealing of wet rooms, for example bathrooms. Material of the connecting profile 100, for example plastics, may be chosen suitably so that, on the other hand, the water sealing paste will adhere to the surface and the grooves 101, 103 of the connecting profile 100 and, on the other hand, the connecting profile 100 may be fixed tightly to a structure (for. ex. 200 in FIG. 2a).

FIG. 2a shows as the structure fixed to the connecting profile 100 a floor drain element 200, to which a connecting profile 100 according to an embodiment of the invention is attached fixedly and tightly.

FIG. 2b shows a cross-section of the floor drain element 200 of FIG. 2a in a situation where the element 200 and the connecting profile 100 are installed. Floor drain element 200, for example of cylindrical shape, is attached fixedly to the concrete casting 202. The floor drain element 200 may also be of another shape, for example a rectangle. A connecting profile 100 of shape matching with the floor drain element 200, for example annular, is fixed tightly^{,} to the floor drain element 200, for example by gluing, welding or any other suitable connection method well known to a person skilled in the art, A layer of water sealing paste 201 is applied on the concrete casting 202 and the connecting profile for example with a roll, spattle or brush. During application the paste penetrates the grooves 101, 103 of the connecting profile 100, and also the broader points 102, 104 thereof. Air possibly trapped in the air pockets of the broader points 102 and 104 exits the grooves 101, 103 via openings 105 and 106. After drying the water insulation layer 201 is adhered fixedly both to the concrete casting 202 and the grooves 101, 103 of the connecting profile 100. As a final result a water tight connection point is obtained between the floor drain element 200 and the concrete casting 202 by means of water sealing paste and using only few working steps.

It is evident to a person skilled in the art that for sake of clarity of the description the exemplary embodiments shown above are relatively simple as regards their structure and functionality. Using the model presented in this patent application it is possible to construct different solutions which take advantage of the inventive principle presented in this patent application. The connecting profile 100 may for example be of any shape, including a straight lath which may allow mounting water tightly for example an edge of a floor drain which extends along the whole wall.

While the present invention has been described in accordance with preferred compositions and embodiments, it is to be understood that certain substitutions and alterations may be made thereto without departing from the spirit and scope of the following claims.

We claim:

1. A connecting profile for binding water sealing paste to a structure at an edge of a zone to be protected by wet sealing, comprising:
the connecting profile being adapted to be attached lightly to a structure, and
the connecting profile together with the structure having a groove defined therein adapted to receive a water sealing paste applied on the connecting profile.

2. The connecting profile according to claim 1, the groove comprises a broader and a narrower point, the narrower point being situated closer to an upper surface of the installed connecting profile than the broader point.

3. The connecting profile according to claim 2, wherein the connecting profile has an one opening defined therein and arranged on the broader point of the groove for leading gas out of the groove during application of the water sealing paste.

4. The connecting profile according to claim 1, wherein the structure is a floor drain element or part of the floor drain.

5. The connecting profile according to claim 1, wherein the connecting profile is impermeable to water sealing paste.

6. A structure to be fixed on an edge of a surface to be wet-sealed, comprising:
a connecting profile having a groove defined therein, and
the groove being adapted to receive a water sealing paste applied on the connecting profile.

7. The structure according to claim 6, wherein an upper surface of the connecting profile is adapted to be mounted substantially on a level of the surface to be wet-sealed.

8. The structure according to claim 6, wherein the structure comprises a floor drain arrangement or part of the floor drain.

9. A method for attaching a water sealing paste to an edge of a zone to be protected by wet sealing using the connecting profile according to claim 1 or the structure according to claim 6.
